(19) United States
(12) Patent Application Publication
(10) Pub. No.: US 2015/0037582 A1
(43) Pub. Date: Feb. 5, 2015

(54) CONTINUOUS PROCESS FOR COATING STEEL WIRE CORD

(71) Applicant: Bridgestone Americas Tire Operations, LLC, Nashville, TN (US)

(72) Inventors: Byron L. Jones, Akron, OH (US); William J. Corsaut, Uniontown, OH (US); William L. Hergenrother, Akron, OH (US); Christine Domer, Uniontown, OH (US)

(73) Assignee: Bridgestone Americas Tire Operations, LLC, Nashville, TN (US)

(21) Appl. No.: 14/373,786

(22) PCT Filed: Jan. 24, 2013
(86) PCT No.: PCT/US13/22871

§ 371 Date: Jul. 22, 2014

Related U.S. Application Data
(60) Provisional application No. 61/590,405, filed on Jan. 25, 2012.

(51) Int. Cl. B05D 1/18; B60C 9/00; C23C 26/00; B05D 3/02; C23C 18/38; C23C 18/31

(52) U.S. Cl. CPC B05D 1/18; C23C 18/38; C23C 18/31; C23C 26/00; B05D 3/0209; B05D 3/0254; B60C 9/0007; B60C 2009/0021; B60C 2009/0014
USPC 428/382; 427/379; 427/380; 428/390; 428/383

(57) ABSTRACT

Continuous processes for producing a coated steel wire are provided. The processes entail wetting steel wire in an aqueous solution comprising at least 95% water and 0.01 to 5% weight/weight of the carboxylic acid salt of an alkoxy modified silsesquioxane of formula (I), evaporating water from the wet coated steel wire to form a mostly-dry coated steel wire and then heating (one or more steps) the mostly-dry coated steel wire at a temperature of 50-240° C. such that the steel wire reaches a minimum temperature of at least 110° C. in at least one step, thereby forming a dry coated steel wire. The coated steel wire is optionally covered with rubber skim or otherwise embedded into rubber and can be incorporated into various objects including tires, conveyor belts, hoses and the like. The silsesquioxane coating improves adhesion between the steel wire and the rubber skim/other rubber covering.

### CROSS-REFERENCE TO RELATED APPLICATION

This application claims priority to and any other benefit of U.S. Provisional Patent Application Ser. No. 61/590,405, filed Jan. 25, 2012 and entitled “CONTINUOUS PROCESS FOR COATING STEEL WIRE CORD,” the entire disclosure of which is incorporated by reference herein.

### FIELD OF THE INVENTION

The present application relates to continuous processes for providing steel wire cord with a coating of the carboxylic acid salt of an alkoxy modified silsesquioxane of formula (I). The continuous processes produce steel wire having a coating with a thickness between 5 and 3000 nm. The coating acts to provide increased adhesion between the underlying steel wire and any rubber skimming that is added to the coated wire.

### BACKGROUND

The continuous processes disclosed, described and claimed herein provide improved methods for producing a silsesquioxane-based coating over steel wire. The silsesquioxane-based coating is formed from the carboxylic acid salt of an alkoxy modified silsesquioxane of formula (I) which is an amino alkoxy modified silsesquioxane and optionally an amino mercapto co-alkoxy modified silsesquioxane. Using the continuous processes, it is now possible to provide long, continuous lengths of steel wire (such as an entire spool of steel wire) with a silsesquioxane coating without the need for cutting or handling the steel wire during the process. The continuous processes enable the use of the coated steel wire in various industrial manufacturing processes, such as embedding in rubber skim stock for use in tires. By the continuous processes disclosed and described herein, the overall coating process can be performed relatively more quickly, with less variation and will produce more consistent results (e.g., in terms of the thickness, consistency and integrity of the silsequioxane coating).

### SUMMARY

The embodiments disclosed herein relate to continuous processes for providing steel wire with a coating of the carboxylic acid salt of an alkoxy modified silsesquioxane of formula (I). The alkoxy modified silsesquioxane of formula (I) is as follows:

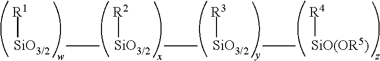

wherein w, x, y and z represent mole fractions, z does not equal zero, at least one of w, x or y must also be present and w+x+y+z=1.00; wherein at least one of R¹, R², R³ and R⁴ must be present and selected from the group consisting of R⁶Z, wherein Z is selected from the group consisting of NH₂, HNR⁷, HNR⁷NH₂ and NR⁷₂ and the remaining R¹, R², R³ and R⁴ are the same or different and selected from the group consisting of (i) H or an alkyl group having one to about 20 carbon atoms, (ii) cycloalkyl groups having 3 to about 20 carbon atoms, (iii) alkylaryl groups having 7 to about 20 carbon atoms, (iv) R⁶X, wherein X is selected from the group consisting of Cl, Br, SH, SₐR⁷, NR⁷₂, OR⁷, CO₂H, SCOR⁷, CO₂R⁷, OH, olefins, epoxides, amino groups, vinyl groups, acrylates and methacrylates, wherein a=1 to about 8, and (v) R⁶YR⁸X, wherein Y is selected from the group consisting of O, S, NH and NR⁷; wherein R⁶ and R⁸ are selected from the group consisting of alkylene groups having one to about 20 carbon atoms, cycloalkylene groups having 3 to about 20 carbon atoms, and a single bond; and R⁵ and R⁷ are selected from the group consisting of alkyl groups having one to about 20 carbon atoms, cycloalkyl groups having 3 to about 20 carbon atoms and alkylaryl groups having 7 to about 20 carbon atoms. The coating that is created by the continuous processes described herein has a thickness between 5 and 3000 nm.

In certain embodiments, the continuous process includes wetting steel wire in an aqueous solution that comprises at least 95% water and 0.01 to 5% weight/weight of the carboxylic acid salt of an alkoxy modified silsesquioxane of formula (I) to form a wet coated steel wire. Thereafter, water is evaporated from the wet coated steel wire forming a mostly-dry coated steel wire. The mostly-dry coated steel wire is then heated, in one or more steps at a temperature between 50 and 240° C., such that the steel wire reaches a minimum temperature of at least 110° C. in at least one step, thereby forming a dry coated steel wire with a coating having a thickness between 5 and 3000 nm.

In other embodiments, the continuous process includes passing steel wire through an aqueous solution with a pH between 4 and 6.5, said solution comprising at least 95% water and 0.01 to 5% weight/weight of the carboxylic acid salt of an alkoxy modified silsesquioxane of formula (I) to form a wet coated steel wire. Thereafter, water from the wet coated steel wire is evaporated using an air current, thereby forming a mostly-dry coated steel wire. The mostly-dry coated steel wire is then heated at a temperature between 50 and 240° C. such that the steel wire reaches a minimum temperature of at least 110° C. during the heating, thereby forming a dry coated steel wire with a silsesquioxane coating of thickness between 5 and 3000 nm. The heating may take place in one step or more than one step as long as the steel wire reaches a minimum temperature of at least 110° C. during at least one point (or during at least one step) in the heating process.

The processes provided and described herein are continuous processes. What is meant by a continuous process is that all of the steps (i.e., wetting, evaporating to mostly-dry and heating to form a dry coated steel wire) can be performed without interruption. In other words, the continuous processes provided herein eliminate the need for intermediary handling steps during the process of forming the silsesquioxane coating upon the steel wire. The continuous processes also allow for the coating of a significantly longer length of wire (e.g., many meters or an entire spool of wire) instead of the discrete pieces of cut wire that can be coated using previous dip processes. By providing a process capable of continuously coating and producing long lengths of silsesquioxane coated steel wire, the use of the coated steel wire in various industrial manufacturing processes, such as embedding in rubber skim stock for use in tires, is enabled. By the processes disclosed herein, the overall coating process can be performed relatively more quickly, with less variation and will produce more consistent results (e.g., in terms of the thickness, consistency and integrity of the silsequioxane coating).

### DETAILED DESCRIPTION

The present disclosure relates to continuous processes for providing steel wire with a coating of the carboxylic acid salt of an alkoxy modified silsesquioxane of formula (I). As used herein, the term “alkoxy modified silsesquioxane” is used interchangeably with the abbreviation “AMS.” The coating that is added to the steel wire acts to provide increased adhesion between the underlying steel wire and any rubber skimming that is added to the coated wire.

In the embodiments disclosed herein, are provided continuous processes for providing steel wire with a coating of the carboxylic acid salt of an alkoxy modified silsesquioxane of formula (I). The alkoxy modified silsesquioxane of formula (I) is as follows:

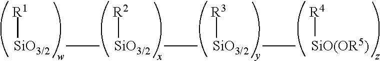

wherein w, x, y and z represent mole fractions, z does not equal zero, at least one of w, x or y must also be present (i.e., is not zero) and w+x+y+z=1.00; wherein at least one of R¹, R², R³ and R⁴ must be present and selected from the group consisting of R⁶Z, wherein Z is selected from the group consisting of NH₂, HNR⁷, HNR⁷NH₂ and NR⁷₂ and the remaining R¹, R², R³ and R⁴ are the same or different and selected from the group consisting of (i) H or an alkyl group having one to about 20 carbon atoms, (ii) cycloalkyl groups having 3 to about 20 carbon atoms, (iii) alkylaryl groups having 7 to about 20 carbon atoms, (iv) R⁶X, wherein X is selected from the group consisting of Cl, Br, SH, SₐR⁷, NR⁷₂, OR⁷, CO₂H, SCOR⁷, CO₂R⁷, OH, olefins, epoxides, amino groups, vinyl groups, acrylates and methacrylates, wherein a=1 to about 8, and (v) R⁶YR⁸X, wherein Y is selected from the group consisting of O, S, NH and NR⁷; wherein R⁶ and R⁸ are selected from the group consisting of alkylene groups having one to about 20 carbon atoms, cycloalkylene groups having 3 to about 20 carbon atoms, and a single bond; and R⁵ and R⁷ are selected from the group consisting of alkyl groups having one to about 20 carbon atoms, cycloalkyl groups having 3 to about 20 carbon atoms and alkylaryl groups having 7 to about 20 carbon atoms. The coating that is created by the continuous processes described herein has a thickness between 5 and 3000 nm.

In certain embodiments, the process includes wetting steel wire in an aqueous solution that comprises at least 95% water and 0.01 to 5% weight/weight of the carboxylic acid salt of an alkoxy modified silsesquioxane of formula (I) to form a wet coated steel wire. Thereafter, water is evaporated from the wet coated steel wire forming a mostly-dry coated steel wire. The mostly-dry coated steel wire is then heated, in one or more steps, at a temperature between 50 and 240° C., such that the steel wire reaches a minimum temperature of at least 110° C. in at least one step, thereby forming a dry coated steel wire with a coating having a thickness between 5 and 3000 nm. In certain embodiments, the mostly-dry coated steel wire is heated, in one or more steps, at a temperature between 140 and 240° C., such that the steel wire reaches a minimum temperature of at least 110° C. in at least one step, thereby forming a dry coated steel wire with a coating having thickness between 5 and 3000 nm. The phrase “at a temperature” (used in the foregoing sentence and at other places herein) is meant to refer to the temperature the wire is exposed to during heating (e.g., the temperature of the atmosphere in an oven). Thus, it is contemplated that when more than one heating step is utilized, one (or more) of the steps may use heating at a temperature less than 110° C. as long as at least one other step uses a higher temperature that is sufficient to cause the dry coated steel wire to reach a minimum temperature of at least 110° C.

In other embodiments, the process includes passing steel wire through an aqueous solution with a pH between 4 and 6.5, said solution comprising at least 95% water and 0.01 to 5% weight/weight of the carboxylic acid salt of an alkoxy modified silsesquioxane of formula (I) to form a wet coated steel wire. Thereafter, water from the wet coated steel wire is evaporated using an air current, thereby forming a mostly-dry coated steel wire. The mostly-dry coated steel wire is then heated at a temperature between 50 and 240° C. (and in certain embodiments at a temperature between 140 and 240° C.) such that the steel wire reaches a minimum temperature of at least 110° C. during the heating, thereby forming a dry coated steel wire with a continuous silsesquioxane coating of thickness between 5 and 3000 nm. The heating may take place in one step or more than one step as long as the steel wire reaches a minimum temperature of at least 110° C. during at least one point (or during at least one step) in the heating process.

In certain embodiments, the aqueous solution of at least 95% water and 0.01 to 5% weight/weight of the carboxylic acid salt of an alkoxy modified silsesquioxane of formula (I) has a pH between 6.5 and 4 (this range, and all other ranges within, including each endpoint). (The amounts of water and carboxylic acid salt are indicated in terms of the weight percentage of each based upon the total weight of the aqueous solution.) In other embodiments, the aqueous solution has a pH between 6 and 5. In yet other embodiments, the aqueous solution contains at least 98% water and 0.01 to 2% of the carboxylic acid salt of an alkoxy modified silsesquioxane of formula (I) (such embodiments may have a pH between 6.5 and 4, between 6 and 5 or between 6.2 and 5.5).

As should be clear to those of skill in the art from a review of formula (I), the alkoxy modified silsesquioxane of formula (I) is an amino-functionalized silsesquioxane. In certain embodiments, the alkoxy modified silsesquioxane of formula (I) is an amino-mercapto AMS. In certain of the foregoing embodiments, the amount of mercapto functionalized silsesquioxane is 10-45 mole % and the amount of amino functionalized silsesquioxane is 55 to 90 mole %. (The mole % of mercapto functionalized silsesquioxane and amino functionalized silsesquioxane is calculated based upon the sum of w, x, y and z groups being 100% and represents the percentage of such groups containing as an R¹, R², R³ or R⁴ group a mercapto or amino group, respectively.) In other such embodiments, the amount of mercapto functionalized silsesquioxane is 12-40 mole % and the amount of amino functionalized silsesquioxane is 60-88 mole %. In yet other such embodiments, the amount of mercapto functionalized silsesquioxane is 15-35 mole % and the amount of amino functionalized silsesquioxane is 65-85 mole %. The preparation of alkoxy functionalized silsesquioxanes of formula (I), including those comprising amino-mercapto functionalized silsesquioxanes is described in U.S. patent application Ser. No. 11/387,569 (now issued as U.S. Pat. No. 7,799,870 and U.S. patent application Ser. No. 12/347,086 (published as U.S. Patent Application Publication No. 2009/1065913). The disclosures of both of the foregoing (as well as the relevant portions of any other patent or patent application publication mentioned herein) are incorporated by reference as if fully set forth herein.

The aqueous solution of the carboxylic acid salt of the alkoxy functionalized silsesquioxane of formula (I) may be prepared by various methods including, but not limited to, those disclosed in U.S. Patent Application Publication No. 2009/0165913. In a preferred method, a solid strong cationic hydrolysis and condensation catalyst is utilized to prepare the silsesquioxane. A reaction mixture is prepared containing (a) water, (b) solvent for the water (e.g., ethanol), (c) a solid strong cationic hydrolysis and condensation catalyst (e.g., Dowex® 50WX series resin), (d) carboxylic acid, and (e) functionalized trialkoxysilanes (e.g., mercaptoalkyltrialkoxysilane, aminotrialkoxysilane). The mixture is allowed to react, preferably with stirring, for a period of 1-24 hours, alternatively 2-16 or 3-8 hours (in certain situations, it may be desirable to increase the speed of the reaction by the application of heat), thereby forming the carboxylic acid salt of the AMS of formula (I). After the allotted reaction time has passed, the catalyst can be recovered by filtering (assuming it is a resin-based catalyst). Residual alcohol remaining in the solution after catalyst removal can be reduced or removed by the addition of water with subsequent distillation and nitrogen purge to remove alcohol, resulting in a solution that is free or essentially free of alcohol. The aqueous solution that is used to wet the steel wire should contain less than 5% by weight of alcohol, preferably less than 3% by weight and even more preferably less than 1% by weight of alcohol. If necessary, the pH of the aqueous solution can be adjusted using additional carboxylic acid or water so that the final solution (before it contacts the steel wire) comprises at least 95% water and 0.01 to 5% weight/weight of the carboxylic acid salt of an alkoxy modified silsesquioxane of formula (I) and has a pH of 4 to 6.5. As discussed above, in certain embodiments, the final solution will: (a) have a pH of 5 to 6.5 and/or (b) contain at least 98% water and 0.01 to 2% weight/weight of the carboxylic acid salt of an alkoxy modified silsesquioxane of formula (I). In other embodiments, the final solution will have a pH of 5.5 to 6.2 and contain either at least 95% water or at least 98% water and 0.01 to 5% or 0.01 to 2% weight/weight of the carboxylic acid salt of an alkoxy modified silsesquioxane of formula (I), respectively.

Suitable solid strong cationic hydrolysis and condensation catalysts are commercially available and include, but are not limited to, cationic ion exchange resins that have sulfonic acid groups attached to an insoluble polymeric matrix. For example, these solid resins contain a H⁺ counter ion that is a strong cation exchanger due to its very low pKa (<1.0). As a non-limiting example, such cationic ion exchange resins can be prepared by sulfonating (by treating with sulfuric acid) a polystyrene that has been crosslinked with about 1 percent to about 8 percent divinylbenzene. Examples of suitable commercially available strong cationic exchange resins include, but are not limited to, the H⁺ ionic form of Amberlite IR-120, Amberlyst A-15, Purolite C-100, and any of the Dowex® 50WX series resins. Such resins are typically gel beads having particle sizes of about 400 mesh to about 50 mesh. Particular particle size is not crucial in preparing the silsesquioxane. Other types of solid supports for the strong cationic ions are available, including, but not limited to, polymer strips, polymer membranes, and the like, and are within the scope of the invention. Preferably, the solid strong cationic catalysts are in a physical form that, after the silsesquioxane is formed, will precipitate (or sink) to the bottom of the reaction chamber for simple separation from the reaction mixture, such as by filtration or the like.

In an alternative method, a reaction mixture is prepared that contains (a) water, (b) solvent for the water (e.g., ethanol), (c) a hydrolysis and condensation catalyst (with a strong organic base such as DBU (1,8-diazabicyclo[5.4.0]undec-7-ene) or DBN (1,5-diazabicyclo-[4.3.0]non-5-ene)), and (d) functionalized trialkoxysilanes (e.g., mercaptoalkyltrialkoxysilane, aminotrialkoxysilane). The reaction mixture is allowed to react for about 0.5 hours to about 200 hours (alternatively 0.75 hours to 120 hours or 1 hour to 72 hours) to form the resulting alkoxy functionalized silsesquioxane of formula (I). Neutralization of the base can be achieved with the use of weak acid(s) non-limiting examples of which include, weak carboxylic acids such as acetic acid, ascorbic acid, itaconic acid, lactic acid, malic acid, naphthilic acid, benzoic acid, o-toluic acid, m-toluic acid, p-toluic acid, and mixtures thereof. The alkoxy functionalized silsesquioxane of formula (I) that results can be recovered after reduction or removal of residual alcohol and by-product alcohol such as by heating (e.g., to 70 to 80° C.) followed by a nitrogen purge. This results in a solution that is free or essentially free of alcohol (the solution should contain less than 5% by weight of alcohol, preferably less than 3% by weight and even more preferably less than 1% by weight of alcohol). The solution is then diluted with water and if needed with additional carboxylic acid to yield the carboxylic acid salt of the alkoxy functionalized silsesquioxane of formula (I) that comprises at least 95% water and 0.01 to 5% weight/weight of the carboxylic acid salt of an alkoxy modified silsesquioxane of formula (I) and has a pH of 4 to 6.5. In certain embodiments, the final solution will: (a) have a pH of 5 to 6.5 and/or (b) contain at least 98% water and 0.01 to 2% weight/weight of the carboxylic acid salt of an alkoxy modified silsesquioxane of formula (I). In other embodiments, the final solution will have a pH of 5.5 to 6.2 and contains either at least 95% water or at least 98% water and 0.01 to 5% or 0.01 to 2% weight/weight of the carboxylic acid salt of an alkoxy modified silsesquioxane of formula (I). More complete information concerning this alternative method of preparing the carboxylic acid salt of an alkoxy modified silsesquioxane of formula (I) can be found in U.S. Patent Application Publication No. 2009/0165913.

Non-limiting examples of the solvent for the water include: alcohols (e.g., ethanol, propanol and iso-propanol), tetrahydrofuran, 1,4-dioxane, 1,3-dioxolane, acetone, acetonitrile and mixtures of these.

Examples of suitable aminotrialkoxy silane reactants include, but are not limited to, 3-[N-(trimethoxysilyl)-propyl]-ethylenediamine, 3-[N-(triethoxysilyl)-propyl]-ethylenediamine, 3-aminopropyltriethoxysilane, 3-aminopropyltrimethoxysilane, 3-aminopropyltributoxysilane, 3-aminopropyltripropoxysilane and the like. In certain embodiments, the “alk” portion of the aminotrialkoxy silane is preferably meth- or eth-. In other words, in such embodiments, the R⁵ group is methoxy or ethoxy and the aminotrialkoxy silane is an aminotrimethoxy silane or an aminotriethoxy silane. Examples of suitable sulfur-containing trialkoxysilanes include, but are not limited to mercaptoalkyltrialkoxysilanes, blocked mercaptoalkyltrialkoxysilanes, 3-mercaptopropyltrialkoxysilane, 3-thioacylpropyltrialkoxy-silane, 3-thiooctanoyl-propyltrialkoxysilane, and the like. Use of a sulfur-containing trialkoxysilane along with the aminotrialkoxy silane is preferred, and mercaptoalkyltrialkoxysilanes are particularly preferred. In certain embodiments, 3-mercaptopropyl triethoxysilane or 3-mercaptopropyl trimethoxysilane is utilized along with the aminotrialkoxysilane.

As used herein, the term “blocked mercaptoalkyltrialkoxysilane” is defined as a compound capable of functioning as a mercaptosilane silica coupling agent that comprises a blocking moiety that blocks the mercapto part of the molecule (i.e., the mercapto hydrogen atom is replaced by another group, hereafter referred to as “blocking group”) while not affecting the reactivity of the mercaptosilane moiety. Suitable blocked mercaptosilanes can include, but are not limited to, those described in U.S. Pat. Nos. 6,127,468; 6,204,339; 6,528,673; 6,635,700; 6,649,684; 6,683,135; the disclosures of which are hereby incorporated by reference with respect to the examples described. As used herein, the silica-reactive “mercaptosilane moiety” is defined as the molecular weight equivalent to the molecular weight of 3-mercaptopropyltriethoxysilane.

In general, a suitable amino co-AMS compound can be manufactured by the co-hydrolysis and co-condensation of an aminotrialkoxysilane with, for example, a mercaptoalkyltrialkoxysilane to introduce a mercaptoalkyl functionality, or with a blocked mercaptoalkyltrialkoxysilane to introduce a blocked mercaptoalkyl functionality. In another arrangement, a blocking agent can be bonded to an amino AMS adhesive containing an SH group after the condensation reaction, as described in the above-referenced U.S. Pat. No. 7,799,870. Moreover, the amino alkoxy silsesquioxane and/or the amino/mercapto co-alkoxy silsesquioxane may also be combined with any AMS and/or co-AMS, such as those described in U.S. Pat. No. 7,799,870.

As discussed above, the wet coated steel wire that is formed by wetting the steel wire with an aqueous solution of at least 95% by weight water and 0.01 to 5% weight/weight carboxylic acid salt of an alkoxy modified silsesquioxane of formula (I) should be allowed to dry in large part prior to being heated at a temperature between 50 and 240° C. The water is evaporated from the wet coated steel wire to form a mostly-dry coated steel wire (in other words, the water is preferably not removed by the use of any type of wiping or other operation that could remove or disturb the not-yet-dry silsesquioxane). Optionally an air current (the air current may contain air that is at or above room temperature (25° C.) and is preferably at a temperature of 50-80° C.) is used to aid in the evaporation of the water. Most (but not entirely all) of the water that was added to the steel wire from the aqueous solution is evaporated from the wet coated steel wire prior to the heating step. The relatively rapid removal of most of the water through evaporation is helpful as a first step in solidifying or drying the coating on the wire. Allowing some small amount of water to remain in the coating prior to the heating step leads to a better dry coating on the steel wire (in terms of adhesion of the coating and hardness of the cured coating). The term “mostly-dry coated steel wire” is used herein to identify the coated steel wire after water has been evaporated from the wet coated steel wire and prior to heating at a temperature between 50 to 240° C.

As previously discussed, the aqueous solution used to wet the steel wire comprises 0.01 to 5% weight/weight of the carboxylic acid salt of an alkoxy modified silsesquioxane of formula (I) and in certain embodiments 0.01 to 2% weight/weight of the carboxylic acid salt of an alkoxy modified silsesquioxane of formula (I). The carboxylic acid salt may be generated by treating the alkoxy modified silsesquioxane of formula (I) with a weak carboxylic acid. Suitable carboxylic acids include, but are not limited to, acetic acid, ascorbic acid, itaconic acid, lactic acid, malic acid, naphthalic acid, benzoic acid, o-toluic acid, m-toluic acid, p-toluic acid and mixtures thereof. Particularly preferred is acetic acid and the acetic acid salts of an alkoxy modified silsesquioxane of formula (I) that result.

In certain embodiments, the z group within the carboxylic acid salt of an alkoxy modified silsesquioxane of formula (I) generates only 0.05% to 10% by weight alcohol (based upon the weight of the carboxylic acid salt of the alkoxy modified silsesquioxane of formula (I) produced) when the compound is treated by substantially total acid hydrolysis. In other embodiments, the amount of alcohol generated is 0.5 to 8% by weight or 1% to 6% by weight. In yet other embodiments, the amount of alcohol generated is less than 1% by weight based upon the total weight of the aqueous solution.

The amount of residual reactive alkoxysilyl groups in each of the carboxylic acid salts of an alkoxy modified silsesquioxane of formula (I) can be measured by according to the method published in Rubber Chemistry & Technology 75, 215 (2001). Briefly, a sample of the product is treated by total acid hydrolysis using a siloxane hydrolysis reagent (0.2 N toluenesulfonic acid/0.24 N water/15% n-butanol/85% toluene). This reagent quantitatively reacts with residual alkoxysilane (e.g., ethoxysilane (EtOSi) or methoxysilane (MeOSi)), freeing a substantially total amount of alcohol (e.g., ethanol or methanol) that is then measured by a headspace/gas chromatographic technique, and expressed as the percentage by weight in the sample.

In those embodiments where the dry coated steel wire is embedded in a rubber skim stock, suitable rubbers for the skim stock generally comprise natural and synthetic rubbers such as those used in the preparation of tires. However, the rubber is not limited to a rubber skim stock. Particular examples of suitable rubbers useful in the processes disclosed herein include natural rubber, synthetic rubbers containing conjugated diene monomer and optionally monolefinic monomer and combinations thereof. More particular examples include polybutadiene, styrene-butadiene, natural rubber, polyisoprene and styrene-butadiene-isoprene rubbers and combinations thereof. Suitable polybutadiene rubber is elastomeric and has a 1,2-vinyl content of about 1 to 3 percent and a cis-1,4 content of about 96 to 98 percent. Other butadiene rubbers, having up to about 12 percent 1,2-content, may also be suitable with appropriate adjustments in the level of other components, and thus, substantially any high vinyl, elastomeric polybutadiene can be employed. Suitable copolymers may be derived from conjugated dienes such as 1,3-butadiene, 2-methyl-1,3-butadiene-(isoprene), 2,3-dimethyl-1,2-butadiene, 1,3-pentadiene, 1,3-hexadiene and the like, as well as mixtures of the foregoing dienes. The preferred conjugated diene is 1,3-butadiene.

As to the monoolefinic monomers, these include vinyl aromatic monomers such as styrene, alpha-methyl styrene, vinyl naphthalene, vinyl pyridine and the like as well as mixtures of the foregoing. Copolymers of conjugated diene monomer and monolefinic monomer may contain up to 50 percent by weight of the monoolefin based upon total weight of copolymer. The preferred copolymer is a copolymer of a conjugated diene, especially butadiene, and a vinyl aromatic hydrocarbon, especially styrene. Preferably, the rubber compound can comprise up to about 35 percent by weight styrene-butadiene random copolymer, preferably 15 to 25 percent by weight. In certain embodiments, the rubber polymer(s) used in the processes disclosed herein can comprise either 100 parts by weight of natural rubber, 100 parts by weight of a synthetic rubber or blends of synthetic rubber or blends of natural and synthetic rubber such as 75 parts by weight of natural rubber and 25 parts by weight of polybutadiene. Polymer type, however is not deemed to be a limitation to the practice of the processes disclosed and described herein.

The above-described rubbers including copolymers of conjugated dienes and their method of preparation are well known in the rubber and polymer arts. Many of the polymers and copolymers are commercially available. It is to be understood that practice of the processes disclosed and claimed herein is not limited to any particular rubber included hereinabove or excluded.

In certain embodiments, the rubber or rubbers used to cover the dry coated steel wire may contain added cobalt in the form of cobalt salt(s) added as a bonding agent to increase adhesion of the rubber or rubbers to the wire. Cobalt salts are often used in rubber compounds skimmed over brass-plated steel wire. In certain embodiments, the rubber or rubbers used to cover the dry coated steel wire made by the processes disclosed herein contain a limited amount of cobalt, more specifically less than 0.25 phr (0.25 parts cobalt per 100 parts of rubber), optionally 0 phr cobalt.

Various methods may be employed for the step of evaporating water from the wet coated steel wire (i.e., after the steel wire has been wetted with an aqueous solution of the carboxylic acid salt of an alkoxy modified silsesquioxane of formula (I)) before it is heated at a temperature between 50 and 240° C. (or between 140 and 240° C. in certain embodiments). In certain embodiments, the evaporation of the water is aided by passage of air or an air current over the surface of the wet coated steel wire. The temperature of such air is optimally at least room temperature (or at least 25° C.) and in certain embodiments is preferably between 50-80° C. The methods and apparatus used to generate any such air current is not particularly limited. It is noted that while the surface of the mostly-dry coated steel wire may feel dry to the touch, it may retain within the structure of the coating a small amount of water that is not easily perceptible by unaided human touch or visual inspection. Hence, it is not required that all of the water be evaporated from the wet coated steel wire prior to the heating step.

In the processes described herein, the mostly-dry coated steel wire is heated at a temperature between 50 and 240° C. In certain embodiments, the heating is at a temperature between 110 and 200° C. and/or at a temperature between 130 and 180° C. and/or at a temperature between 140 and 240° C. The heating takes place in one or more steps such that the steel wire reaches a minimum temperature of at least 110° C. at some point during the heating process. In certain embodiments, the heating takes place in one step. In other embodiments, the heating takes place in two, three or more steps. As mentioned, in at least one step the steel wire must reach a temperature of at least 110° C. (in order to ensure that any remaining water is driven off of the coating). In certain embodiments, the heating occurs in multiple steps and the temperature within each step progressively increases. The amount of time for the heating step or steps may vary according to the particular heating process utilized. In certain embodiments, the steel wire reaches a minimum temperature of at least 110° C. for at least 30 seconds, at least 1 minute or at least 2 minutes. In other embodiments, different time limitations may apply. The particular process and apparatus used in the heating step is not particularly limited as long as the mostly-dry coated steel wire reaches a minimum temperature of at least 110° C.

As discussed above, the silsesquioxane coating that remains on the dry coated steel wire has a thickness between 5 and 3000 nm. In certain embodiments, the thickness of the coating is between 5 and 300 nm. The thickness of the coating may be measured according to various methods, including, but not limited to SEM analysis. (Generally, as part of such analysis an acid is used to etch away the steel cord in order to be able to analyze the coating that is pulled loose by the etching.) In certain embodiments, the coating that results may be uneven or thicker over certain portions of the steel wire than others. In such an instance, the thicknesses mentioned are intended to apply to a large majority of the surface area of the steel word (i.e., at least 70%, preferably at least 80% of the steel wire should have a coating of at least the specified thickness).

In certain embodiments discussed above, the dry coated steel wire is wound around a storage device or cylinder. In such embodiments, the dry coated wire is preferably allowed to cool prior to the winding, preferably to a temperature of less than about 50° C. In certain embodiments, the dry coated temperature is allowed to cool to room temperature prior to winding around any type of storage device or cylinder.

In certain of the embodiments discussed above, the steel wire is made from conventional steel and any type of such steel could be used in practicing the processes disclosed herein. Non-limiting examples include low, medium and high-carbon grades of steel. Low carbon steel is particularly suitable. In other embodiments relating to tires, the type of steel employed is that conventionally used in tire reinforcements. In certain embodiments, the steel wire cord is unplated steel cord, brass coated/plated steel cord, zinc coated/plated steel cord, bronze coated/plated steel cord, plated steel cord at least a portion of which is bright steel and combinations of these. In certain of the embodiments discussed above, the steel wire that is passed through the aqueous solution contains a coating (the coating or plating having been applied prior to the steel wire being passed through the aqueous solution) of a metal selected from the group consisting of zinc, brass, copper and combinations thereof.

### EXAMPLES

### Example 1

### Preparation of Amino-Mercapto AMS (with 30 Mole % Mercapto and 70 Mole % Amino)

The following ingredients were added to a 2 L Erlenmeyer flask (while stifling with a magnetic stir bar): 134.08 g (602.99 mmol) 3-[N-(trimethoxysilyl)propyl]-ethylenediamine, 50.66 g (258.02 mmol) 3-mercaptopropyl triethoxysilane, 394.12 g (499.5 mL) absolute ethanol, 73.07 g (1.217 mol) acetic acis (1.009 equivalents of acetic acid/moles of amino groups) and 39.98 g (76.76 mmol of acid) water-washed until neutral (by pH paper) and dried Dowex® 50WX2 100-200 mesh size strong cationic polystyrene resin crosslinked with 2% divinylbenzene (available from The Dow Chemical Company, Midland, Mich.). To the suspension was added 130.2 g (7.23 mol) (moles water/moles Si—O-Me=2.81) of distilled water. After a slight exothermic reaction that caused the suspension temperature to increase to about 35° C., the suspension was stirred for 23 hours at ambient temperature (about 25° C.) to give a clear solution of the product and the suspended cationic resin catalyst.

Thereafter, the Dowex® resin was separated by filtration through a medium sintered glass filter. To the filtrate was added approximately 150 mL of distilled water. The resulting clear solution was then heated at 70 to 100° C. with a nitrogen purge to distill of the ethanol solvent and alcohol reaction products along with any excess water. This provided 311.06 g of aqueous solution containing the acetic acid salt of the amino-mercapto co AMS. The aqueous solution had a calculated amino-mercapto co-AMS content of 40.26 weight % (63.54 weight % of the di-carboxylic acid salt of the amino-mercapto co-AMS), 0.21% free acetic acid and 36.25% water. After dilution with additional distilled water to about 5 weight % di-carboxylic acid salt of the amino-mercapto co-AMS, the solution had a pH of 5.59. The stability of the solution was shown by no increase in viscosity, cloudiness or color that would be noted from aging over 12 months.

### Example 2

### Exemplary Method for Producing Coated Steel Wire (Using the Carboxylic Acid Salt AMS of Example 1)

A Litzler Computreater 2000-H (C.A.Litzler Co., Inc., Cleveland, Ohio) was used for purposes of the heating portion of the process. The steel wire utilized was of the configuration 1×5×0.225 (a configuration using 5 filaments twisted into 1 cord with the cord having an overall diameter of 0.225 mm). The steel wire was brass-plated. The carboxylic acid salt of an AMS (as produced in Example 1) was utilized in an aqueous solution containing 0.3 weight % or 0.6 weight % of the carboxylic acid salt of the AMS generated in Example 1 (based upon the total weight of the aqueous solution) which contains 30 mole % mercapto and 70 mole % amino. The aqueous solution had a pH of 6 (as measured using a hand-held pH meter).

About 100-200 mL of the aqueous solution was then placed into a plastic container. The steel wire was unwound from a spool (the spool being that on which it was supplied) and passed under a pulley wheel (of size approximately 4 inches) that had been partially submerged (approximately the lower 1 inch of the wheel was submerged) in the aqueous solution to produce a wet coated steel wire. This set-up allowed the steel wire to maintain contact with the aqueous solution for about 1-2 seconds. After the wet coated steel wire passed out of the aqueous solution and off of the pulley wheel, it was passed by a small fan. The fan blew room temperature air (approximately 25-35° C.) over the surface of the wet coated steel wire to produce a mostly-dry coated steel wire. The mostly-dry coated steel wire then passed into the Litzler machine.

While the Litzler machine utilized contained more than one oven, only one oven was utilized. (As discussed above, it is contemplated that more than one heating step could be utilized and, as such, more than one oven could be utilized.) Various temperature settings were utilized: 170° C. and 180° C. These temperature settings represent the internal temperature of the oven. Various speed settings were utilized on the Litzler machine so that the wire spent either 1 minute or 2 minutes within the oven. As those familiar with the Litzler machine will understand, in order to thread the steel wire through the machine, it was necessary to first thread a quantity of the steel wire into and through the wheels and pulleys of the machine without wetting it or otherwise treating it with the aqueous solution. Once threading had been achieved, the appropriate wire speed was adjusted (a setting of 12-13 yards per minute was utilized). Thereafter, the pulley and aqueous solution container were implemented so that the steel wire was wetted with the aqueous solution and air-dried prior (in the manner discussed above) to entering the Litzler machine. After passing out of the Litzler machine, the wire was wound onto another spool. The wire had a temperature of about 30-50° C. just prior to being wound onto the storage spool.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

What is claimed is:

1-15. (canceled)

16. A process for continuously coating steel wire said process comprising:
wetting steel wire in an aqueous solution comprising at least 95% water and 0.01 to 5% weight/weight of the carboxylic acid salt of an alkoxy modified silsesquioxane meeting the following formula (I) to form a wet coated steel wire 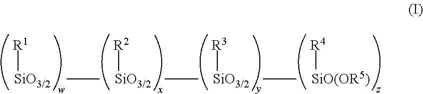
wherein w, x, y and z represent mole fractions, z does not equal zero, at least one of w, x or y must also be present and w+x+y+z=1.00;
wherein at least one of R¹, R², R³ and R⁴ must be present and selected from the group consisting of R⁶Z, wherein Z is selected from the group consisting of NH₂, HNR⁷, HNR⁷NH₂ and NR⁷₂ and the remaining R¹, R², R³ and R⁴ are the same or different and selected from the group consisting of (i) H or an alkyl group having one to about 20 carbon atoms, (ii) cycloalkyl groups having 3 to about 20 carbon atoms, (iii) alkylaryl groups having 7 to about 20 carbon atoms, (iv) R⁶X, wherein X is selected from the group consisting of Cl, Br, SH, SₐW, NR⁷₂, OR⁷, CO₂H, SCOR⁷, CO₂R⁷, OH, olefins, epoxides, amino groups, vinyl groups, acrylates and methacrylates, wherein a=1 to about 8, and (v) R⁶YR⁸X, wherein Y is selected from the group consisting of O, S, NH and NR⁷; wherein R⁶ and R⁸ are selected from the group consisting of alkylene groups having one to about 20 carbon atoms, cycloalkylene groups having 3 to about 20 carbon atoms, and a single bond; and R⁵ and R⁷ are selected from the group consisting of alkyl groups having one to about 20 carbon atoms, cycloalkyl groups having 3 to about 20 carbon atoms and alkylaryl groups having 7 to about 20 carbon atoms;
evaporating water from the wet coated steel wire to form a mostly-dry coated steel wire; and
in one or more steps heating the mostly-dry coated steel wire at a temperature between 50 and 240° C., such that the steel wire reaches a minimum temperature of at least 110° C. in at least one step, thereby forming a dry coated steel wire with a coating of thickness between 5 and 3000 nm.

17. The process of claim 16, wherein
the alkoxy modified silsesquioxane comprises at least 10 mole % mercapto functionalized silsesquioxane and at least 55 mole % amino functionalized silsesquioxane;
the aqueous solution has a pH of between 4 and 6.5;
the step of evaporating water comprises using a warm air current; and
the one or more steps comprises one step of heating at a temperature between 50 and 240° C. such that the steel wire reaches a minimum temperature of at least 110° C. during the heating thereby forming a dry coated steel wire with a continuous silsesquioxane coating of thickness between 5 and 300 nm.

18. The process of claim 16, wherein the aqueous solution comprises 0.01 to 2% weight/volume of the carboxylic acid salt of the alkoxy modified silsesquioxane of formula (I).

19. The process of claim 16, wherein the semi-dry coated steel wire is heated at a temperature between 110 and 240° C. in one step.

20. The process of claim 16, wherein the steel wire that is passed through the aqueous solution contains a coating of a metal selected from the group consisting of zinc, brass, copper, and combinations thereof, prior to being passed through the aqueous solution.

21. The process of claim 16, wherein the alkoxy modified silsesquioxane comprises 10-45 mole % mercapto functionalized silsesquioxane and 55-90 mole % amino functionalized silsesquioxane.

22. The process of claim 16, wherein the carboxylic acid anion results from acetic acid.

23. The process of claim 16, wherein the thickness of the coating on the dry coated steel wire is between 5 and 300 nm.

24. The process of claim 16, wherein the aqueous solution meets at least one of the following: (a) liberates less than 1% by weight alcohol when treated by substantially total acid hydrolysis and (b) has a pH between 4 and 6.5.

25. The process of claim 16, wherein the steel wire that is passed through the aqueous solution contains less than 5% martensite and has an outer coating of a metal selected from the group consisting of zinc, brass, copper and combinations thereof prior to being passed through the aqueous solution.

26. The process of claim 16, wherein the step of evaporating comprises the use of warm air current at a temperature greater than 25° C.

27. The process of claim 16, further comprising embedding the dry coated steel wire in rubber selected from the group consisting of natural rubber, synthetic rubbers containing conjugated diene monomer and combinations thereof to form a rubber skimmed wire.

28. The process of claim 16, wherein the rubber comprises natural rubber containing less than 0.25 phr cobalt.

29. A dry coated steel wire made by the process of claim 16.

30. A tire incorporating the dry coated steel wire made by the process of claim 16.

31. A tire incorporating the rubber skimmed wire of claim 27.

32. A coated steel wire made by a process comprising:
wetting steel wire in an aqueous solution comprising at least 95% water and 0.01 to 5% weight/weight of the carboxylic acid salt of an alkoxy modified silsesquioxane meeting the following formula (I) to form a wet coated steel wire 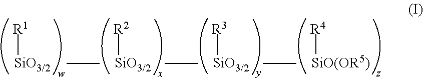
wherein w, x, y and z represent mole fractions, z does not equal zero, at least one of w, x or y must also be present and w+x+y+z=1.00;
wherein at least one of R¹, R², R³ and R⁴ must be present and selected from the group consisting of R⁶Z, wherein Z is selected from the group consisting of NH₂, HNR⁷, HNR⁷NH₂ and NR⁷₂ and the remaining R¹, R², R³ and R⁴ are the same or different and selected from the group consisting of (i) H or an alkyl group having one to about 20 carbon atoms, (ii) cycloalkyl groups having 3 to about 20 carbon atoms, (iii) alkylaryl groups having 7 to about 20 carbon atoms, (iv) R⁶X, wherein X is selected from the group consisting of Cl, Br, SH, SₐW, NR⁷₂, OR⁷, CO₂H, SCOR⁷, CO₂R⁷, OH, olefins, epoxides, amino groups, vinyl groups, acrylates and methacrylates, wherein a=1 to about 8, and (v) R⁶YR⁸X, wherein Y is selected from the group consisting of O, S, NH and NR⁷; wherein R⁶ and R⁸ are selected from the group consisting of alkylene groups having one to about 20 carbon atoms, cycloalkylene groups having 3 to about 20 carbon atoms, and a single bond; and R⁵ and R⁷ are selected from the group consisting of alkyl groups having one to about 20 carbon atoms, cycloalkyl groups having 3 to about 20 carbon atoms and alkylaryl groups having 7 to about 20 carbon atoms;
evaporating water from the wet coated steel wire to form a mostly-dry coated steel wire; and
in one or more steps heating the mostly-dry coated steel wire at a temperature between 50 and 240° C., such that the steel wire reaches a minimum temperature of at least 110° C. in at least one step, thereby forming a dry coated steel wire with a coating of thickness between 5 and 3000 nm.

33. The coated steel wire of claim 32, where the process comprises at least one of the following (a)-(g):
(a) the alkoxy modified silsesquioxane comprises 10-45 mole % mercapto functionalized silsesquioxane and 55-100 mole % amino functionalized silsesquioxane;
(b) the aqueous solution has a pH of between 4 and 6.5,
(c) the step of evaporating water comprises using a warm air current at a temperature of greater than 25° C.;
(d) the aqueous solution liberates less than 1% by weight alcohol when treated by substantially total acid hydrolysis;
(e) the aqueous solution has a pH between 4 and 6.5; and
(f) the semi-dry coated steel wire is heated at a temperature between 110 and 240° C. in at least one step; and
(g) the thickness of the coating on the dry coated steel wire is between 5 and 300 nm.

34. The coated steel wire cord of claim 32, wherein the process meets the following:
the alkoxy modified silsesquioxane comprises at least 10 mole % mercapto functionalized silsesquioxane and at least 55 mole % amino functionalized silsesquioxane;
the aqueous solution has a pH of between 4 and 6.5;
the step of evaporating water comprises using a warm air current; and
the one or more steps comprises one step of heating at a temperature between 50 and 240° C. such that the steel wire reaches a minimum temperature of at least 110° C. during the heating thereby forming a dry coated steel wire with a continuous silsesquioxane coating of thickness between 5 and 300 nm.

35. The coated steel wire cord of claim 32, wherein the aqueous solution of the process comprises 0.01 to 2% weight/volume of the carboxylic acid salt of the alkoxy modified silsesquioxane of formula (I).
